(19) United States
(12) Patent Application Publication
(10) Pub. No.: US 2024/0280497 A1
(43) Pub. Date: Aug. 22, 2024

(54) DEVICE FOR DETECTING A SPROUTING OF SOWN SEEDS, AGRICULTURAL SENSOR DEVICE, AND AGRICULTURAL MONITORING AND/OR CONTROL METHOD AND SYSTEM

(71) Applicant: ETO MAGNETIC GmbH, Stockach (DE)

(72) Inventors: Tobias PLÖTZING, Bodman-Ludwigshafen (DE); Benjamin BÖNISCH, Bodman-Ludwigshafen (DE)

(21) Appl. No.: 18/567,581

(22) PCT Filed: Jun. 8, 2022
(86) PCT No.: PCT/EP2022/065476

§ 371 Date: Mar. 26, 2024

(30) Foreign Application Priority Data
Jun. 10, 2021 (DE) 10 2021 114 996.7

(51) Int. Cl. G01N 21/84; A01C 21/00; A01G 25/16; G06V 20/10

(52) U.S. Cl. CPC G01N 21/84; A01C 21/007; A01G 25/167; G06V 20/188; G01N 2021/8466

(57) ABSTRACT

A device for a detection of a sprouting of seeds, in particular a seedling detection device and/or a field emergence detection device, including an optical sensor unit, the field of view of which is aligned in a designated operation and/or installation state from a top view onto a ground and which is configured to record image data repeatedly or continuously, and including a data processing unit, which is configured to evaluate the image data of the optical sensor unit at least for a detection of sprouting times of seeds.

### CROSS-REFERENCE TO RELATED APPLICATIONS

This patent application is a U.S. national stage application of international patent application PCT/EP2022/065476, filed on Jun. 8, 2022, which claims priority from and incorporates herein by reference the German patent application DE 10 2021 114 996.7 filed on Jun. 10, 2021.

### PRIOR ART

The invention relates to a device for a detection of a sprouting of seeds, an agricultural sensor device, an agricultural monitoring and/or agricultural control method and an agricultural monitoring and/or agricultural control system.

The point in time of the so-called field emergence is decisive for the success of agricultural planting, since, in order to achieve maximum harvesting success, time schedules for irrigation, plant protection and/or fertilizing measures should be aligned accordingly. Farmers therefore regularly drive down their fields after sowing in order to control the field emergence.

### SUMMARY

The object of the invention is in particular to provide a device with which agricultural processes can be advantageously optimized. The object is achieved according to the invention.

A device for a detection of a sprouting of seeds, in particular a seedling detection device and/or a field emergence detection device, is proposed, with an optical sensor unit, the field of view of which is aligned in a designated operation and/or installation state, in particular of the optical sensor unit, from a top view onto a ground and which is configured to record image data, in particular of the ground, repeatedly or continuously, and with a data processing unit, which is configured to evaluate the image data of the optical sensor unit at least for a detection of sprouting times of seeds. An agricultural cultivation process can thereby advantageously be optimized. Advantageously, an optimized irrigation, plant protection and/or fertilizing measures plan can thereby be created. Advantageously, a harvesting success can thereby ultimately be maximized. Additionally, a control of agricultural processes, sometimes already at least partially automated, can advantageously be optimized. For example, a point in time of use of a pre-emergence herbicide can be optimized, for example in that a point in time can be identified at which first weeds (for example, weeds germinating more superficial) sprout, but the sown crop plant has not yet emerged. Alternatively or additionally, a point in time of use of a post-emergence herbicide, for example a selective post-emergence herbicide and/or a leaf-active post-emergence herbicide, can be optimized. For example, some post-emergence herbicides have to be applied in a specific stage of a crop plant, for example in the case of maize between a 2-leaf stage and a 4-leaf stage or an 8-leaf stage, or before weeds have reached a specific degree of coverage with one another or with the crop plant, in order to be able to achieve an optimal success.

A “sprouting” is to be understood in particular as a start of growth of a plant and preferably an emergence of a plant from the soil. In particular, a “sprouting point in time” of a plant is a point in time at which the plant emerges for the first time from the soil or from a seed lying on the soil/on the topsoil and/or reaches the sunlight. Generally, a plant in the form of a plant shoot, in particular a seedling or a sapling, emerges for the first time from the soil/the topsoil or from the seed. The device for a detection of a sprouting of seeds can therefore also be embodied as a plant sprout detection device, as a seedling detection device, as a sapling detection device or as a device for a detection of parts of the plant embryo, such as cotyledons, hypocotyl and/or protophyll. Advantageously, the device for a detection of a sprouting of seeds is embodied as a field emergence detection device which is configured to detect a planar field emergence of crop plants, preferably in addition to an individual detection of individual plant sprouts, seedlings and/or saplings. In particular, the sprouting point in time is the point in time at which a (planar) field emergence takes place, in particular at least in a monitoring region of the device for a detection of a sprouting of seeds. Alternatively, the sprouting point in time can also be the point in time at which the first sprouting of an individual seedling of a (predetermined) sown crop plant species takes place in the monitoring region of the device for a detection of a sprouting of seeds. Advantageously, emergence diseases or relapse diseases of the seedlings can thereby be avoided, e.g. by adapting a watering plan, by soil disinfection, by soil steaming, by optimizing the sowing quantity, etc.

In particular, the optical sensor unit of the device for a detection of a sprouting of seeds comprises for this purpose a field of view which is large enough to be able to simultaneously monitor a plurality of seed locations, e.g. at least five seed locations of crop plants, preferably at least ten seed locations or preferably at least 25 seed locations. In particular, the (soil) field of view of the optical sensor unit is greater than 10 cm×10 cm, preferably greater than 20 cm×20 cm, advantageously greater than 30 cm×30 cm and preferably greater than 50 cm×50 cm. In particular, the (soil) field of view of the optical sensor unit is additionally selected such that a resolution of the optical sensor unit is sufficient to enable a reliable detection of the crop plants or of spontaneous accompanying vegetation/weeds and/or a reliable differentiation of the crop plants from the spontaneous companion vegetation/the weeds. For example, for this purpose the field of view of the optical sensor unit is generally smaller than 300 cm×300 cm, preferably smaller than 200 cm×200 cm. The optical sensor unit is formed in particular as a camera, for example a camera with a sensitivity in the visual range, in the infrared range or (at least partially) in the infrared and (at least partially) in the visual range. Further, alternatively or additionally, a sensitivity of the camera in at least a part of the ultraviolet spectral range is also conceivable. A “top view” is to be understood in particular as meaning a view obliquely or perpendicularly from above onto an object or a region, in particular the ground/the soil in the monitoring region of the optical sensor unit. In particular, a viewing axis/a field of view center of the field of view of the optical sensor unit in the designated operation and/or installation state of the optical sensor unit is inclined at most by 55°, preferably at most by 45° and preferably at most by 30° to the vertical (with respect to the ground). The ground is formed in particular as a soil, preferably as an agricultural area region arranged in the monitoring region of the optical sensor unit. It is also conceivable that the field of view axis, in particular a field of view center of the optical sensor unit, is aligned at least essentially vertically downward in the designated operation and/or installation state. In particular, the optical sensor unit comprises an autofocus system. In particular, the autofocus system is configured to focus the ground and/or plants emerging from the ground.

The data processing unit comprises at least one processor and at least one memory with an operating program, which is configured to be executed by the processor. In particular, the data processing unit has a non-volatile memory, which is configured to store data of the device for a detection of a sprouting of seeds, in particular image data of the optical sensor unit and/or evaluation data, which were obtained on the basis of the image data of the optical sensor unit. In particular, the optical sensor unit is configured to detect a field emergence on the basis of the image data. Alternatively or additionally, the optical sensor unit is configured to perform an at least rough plant detection on the basis of the image data, in particular on the basis of plant parts of the plant sprout, of the sapling and/or of the seedling (cotyledons, hypocotyl, protophyll, etc.) of plants sprouting in the monitoring region. “Configured” is to be understood in particular as meaning specially programmed, designed and/or equipped. The fact that an object is configured for a specific function is to be understood in particular as meaning that the object fulfils and/or executes this specific function in at least one application and/or operation state. In particular, the optical sensor unit records image data at predetermined intervals, e.g. every hour, every three hours, etc. It is conceivable here that no image data are recorded at night or that a flash device is used at night to enable recording of image data.

In particular, it is conceivable that the data processing unit is additionally configured to perform a person identification on the basis of the image data. In particular, the data processing unit is configured to detect whether identifiable persons were (randomly) recorded in an image of the image data. In particular, the data processing unit is configured to delete images with identifiable persons and preferably to replace them with newly recorded images. Alternatively, the data processing unit can be configured to prevent an external transmission of images with identifiably imaged persons. Advantageously, data protection regulations can thereby be complied with (keyword GDPR conformity).

It is further proposed that the device for a detection of a sprouting of seeds comprises an, in particular wireless, data transmission unit, which is configured at least to send a notification of the sprouting time externally upon detection of a sprouting of the seed. Advantageously, an optimal utilization of the obtained data can thereby be ensured. Advantageously, an optimized control of external systems, such as irrigation, fertilizing and/or plant protection systems, can thereby be achieved. In particular, the external recipient is embodied as a recipient realized separately from the device for a detection of a sprouting of seeds, in particular from an agricultural sensor comprising the device, for example an external server system, an external cloud computing system and/or an external mobile terminal, such as a smartphone.

If the data transmission unit has at least one transmitter, in particular a low power transmitter, which is configured to send data via a low power wide area network protocol (LPWAN network protocol), such as NB-IoT (narrowband IoT), LoRaWAN (long range wide area network) or mioty, a high operational readiness for use in the field can advantageously be achieved, in particular in that particularly long accumulator and/or battery runtimes can be achieved. It is conceivable that data are fed into LPWAN networks such as The Things Network or The People's Network or a proprietary LPWAN network by means of the transmitter. Advantageously, a direct cloud connection can be made possible by the use of NB-IoT. Further, it is conceivable that at least a part of the data transmission takes place via a direct satellite connection (cf. e.g. Griot from SOIL Inc.), in particular an IoT satellite connection.

If further a transmitter of the data transmission unit, in particular the transmitter sending the data via the LPWAN network protocol, preferably low power transmitter, is configured to send one or several plant classification codes, in particular assigned to the plant sprouts detected from the image data, externally upon detection of the sprouting of the seed by the data processing unit, a targeted control of external systems, such as irrigation, fertilizing and/or plant protection systems, can advantageously be made possible. In particular, the data processing unit is configured to perform a plant detection, in particular a plant sprout detection, of plants imaged in the image data, in particular plant sprouts. In particular, the data processing unit has a detection program, which assigns a plant classification code to each detected plant sprout by means of a detection algorithm and/or by means of a classification algorithm. The plant classification code can have different accuracy levels. A first (roughest) accuracy level could comprise a classification into monocots (monocotyledons) and dicots (dicotyledons). A second accuracy level could be a classification into plant orders, for example grass-like plants (including e.g. maize) and non-grass-like plants. A third accuracy level could comprise a classification into (expected) useful plants/crop plants and (undesired) weed plants. A fourth (most exact) accuracy level could be a classification into (expected) known plant species (e.g. useful plant/crop plant: maize, wheat, etc./companion vegetation: lady's thumb, barnyard grass, field pansy, field thistle, goosefoot, etc.). In particular, the transmitter regularly transmits the plant classification codes, e.g. every hour, every three hours, etc. Alternatively, the transmitter could also transmit an update of the plant classification codes only when a change to the previous status is detected. In particular, the detection algorithm is configured to detect whether a plant sprout has already emerged from the topsoil or whether, in particular in comparison with the previously recorded image data, further plant shoots have emerged from the topsoil. In particular, the detection algorithm is based on a pattern and/or shape detection, e.g. a cotyledon/primary leaf count, a cotyledon/primary leaf shape detection, a cotyledon/primary leaf size detection, etc. In particular, the detection algorithm is based on a color detection, in particular a cotyledon/primary leaf color detection. In particular, the detection algorithm and/or the classification algorithm is Al-supported and/or can be trained by machine learning. In particular, it is conceivable that only the plant classification codes are transmitted by the transmitter without associated image data. An energy consumption can thereby advantageously be kept low.

If the plant classification code contains at least one piece of information about whether one or several plant sprouts (sprouted seeds) have been detected by the data processing unit, a progress of the field emergence can advantageously be tracked in real time. A particularly temporally precise agricultural planning can thereby advantageously take place. In particular, the plant classification code comprises a number of detected and/or classified plant sprouts. For example, a transmitted plant classification code comprises the following message: three plant sprouts of class A (crop plant/useful plant), four plant sprouts of class U1 (monocotyledonous weed), one plant sprout of class U2 (dicotyledonous weed) and one plant sprout of class X (unclassified/undetected).

If the plant classification code contains at least one piece of information about which plant type(s) has/have been detected by the data processing unit and/or whether a plant sprout has been assigned to a desired or an undesired plant type by the data processing unit, a particularly temporally precise agricultural planning can advantageously be made possible. Advantageously, a yield can thereby be increased. In particular, at least two types are differentiated in the plant classification code: crop plant and accompanying vegetation. A more precise plant type determination is of course possible and conceivable.

If, in addition, the plant classification code contains at least one piece of information about how many plant sprouts have been detected per unit area by the data processing unit, an efficiency of the field emergence can advantageously be determined, whereby advantageously optimal sowing quantities for the monitored field can be determined. In particular, a ratio of sowing quantity and number of plant sprouts can advantageously be determined from this information. In particular, the efficiency data of the field emergence can be stored in a central database and correlated with other data, e.g. meteorological data, irrigation, fertilizing and/or plant protection application data, soil type data, etc., whereby advantageously optimal sowing quantities can be determined depending on soil type or weather forecast, etc. In particular, the efficiency data of the field emergence or of a subsequently obtained harvesting quantity can be used to draw conclusions for the completed control/the completed use of irrigation, fertilizing and/or plant protection systems and thereby to optimize a manually adjusted control or a control of irrigation, fertilizing and/or plant protection systems trained by machine learning.

It is further proposed that the data transmission unit has a, in particular further, transmitter, which is configured to send the image data of the optical sensor unit externally. A control of the information transmitted via a plant classification code can thereby advantageously take place. For example, a farmer can thereby easily and quickly find out whether the expected field emergence time/sprouting time has actually already been reached or whether it is a false alarm. The further transmitter can be in particular the low-energy transmitter, which also transmits the plant classification codes, or a further low-energy transmitter, which is specifically only configured to transmit the image data, or a transmitter different from a low-energy transmitter, such as e.g. a WiFi transmitter, a Bluetooth transmitter, a mobile radio transmitter, etc. In particular, the transmitter and/or the further transmitter is wireless. Alternatively, a wired transmission or the like, such as by means of a USB stick, is however also conceivable.

In this case, the, in particular further, transmitter is advantageously configured to send image data, which show the detected first-sprouting plant sprout, externally upon first detection of a sprouting of a plant sprout automatically and/or (at any time) upon instruction by an external receiver. As a result, a particularly prompt reaction to the field emergence can advantageously be made possible. Advantageously, an increase in yield can thereby be made possible. Advantageously, emergence diseases or relapse diseases of the seedlings can thereby be avoided. A “first detection of a sprouting of a plant sprout” is to be understood in particular as meaning the first sprouting of a plant sprout within the monitored agricultural area region, preferably the first sprouting of a plant sprout classified as an expected crop plant within the monitored agricultural area region.

It is additionally proposed that the data processing unit, in particular an operating program of the data processing unit, is configured to crop the image data before sending for data reduction in such a way that the sent image data comprise only a reduced image section, which represents the detected first-sprouting plant sprout. An amount of data and/or a transmitter energy consumption can thereby advantageously be kept low.

It is further proposed that the data transmission unit has at least one receiver, which is configured at least to externally receive response data upon the data sent externally. A training of the data processing unit, in particular of at least one algorithm of the data processing unit, preferably of the detection algorithm and/or of the classification algorithm, can thereby advantageously be made possible. The receiver can be embodied in particular as a low-energy receiver based on the LPWAN network protocol or a receiver different from a low-energy receiver, such as e.g. a WiFi receiver, a Bluetooth receiver, a mobile radio receiver, etc. In particular, the receiver is wireless.

In this context it is proposed, that the receiver is configured at least to forward the response data to the data processing unit for a training of the detection algorithms of the data processing unit and/or of the classification algorithms of the data processing unit, in particular of an object classification algorithm of the data processing unit. In particular, the data processing unit is configured to use the received response data for a training and/or training (keyword: “supervised learning”) of an artificial neural network having the detection algorithms, the classification algorithms and/or the object classification algorithms.

Additionally, it is proposed that the data processing unit comprises at least one microcontroller for a detection of the sprouting times by evaluating the image data. Advantageously, a particularly long battery and/or accumulator runtime can thereby be achieved. Advantageously, an analysis of the image data close to the sensor, in particular internal to the agricultural sensor, can additionally be made possible. Alternatively, the analysis of the image data can also be outsourced, for example to a cloud, which, however, is accompanied by a demand for a high bandwidth and thus a high energy consumption. Thus, such a non-close to the sensor solution only makes sense if the framework conditions for bandwidth and energy supply allow this.

In this context it is additionally proposed, that the microcontroller is configured to execute at least one object classification algorithm for evaluating the image data of the optical sensor unit, in particular for a detection of plant sprouts in the image data of the optical sensor unit. Advantageously, a close to the sensor, energy-saving sprouting time detection can thereby be made possible. In particular, the object classification algorithm is based on a pattern detection. Advantageously, the object classification algorithm is Al-supported and/or can be trained by machine learning.

It is further proposed that the data processing unit is configured to evaluate image data of the optical sensor unit at least for a detection of growth rates of plant sprouts, wherein the data transmission unit is configured at least to send the determined growth rates externally. Advantageously, a rate of the field emergence can thereby be monitored, whereby in particular prompt, precise and/or targeted measures can be initiated and/or planned. In particular, the data processing unit is configured to compare successively recorded image data, in particular the detected plant sprouts from successively recorded image data. Preferably, a scale and/or a scale bar is arranged in the agricultural area region, in particular in the field of view of the optical sensor unit, for example on a holding device for the optical sensor unit. In particular, the scale and/or the scale bar is recorded with the image data and read out from the image data by means of the data processing unit. In particular, the scale and/or the scale bar is used by the data processing unit for normalizing the growth rate determined from the image data and/or for assigning a correct physical unit to the growth rate. In particular, the data transmission unit is configured to send the determined growth rates externally without the associated image data, e.g. only as text message.

Furthermore, an agricultural sensor device, preferably an agricultural sensor rod/agricultural sensor post, comprising an, in particular rod-shaped, base body with an anchoring device for an at least partial sinking into a ground and comprising the device assigned to the base body for a detection of a sprouting of seeds is proposed. A simple installation and/or positioning of the device for a detection of a sprouting of seeds can thereby advantageously be achieved. In particular, the agricultural sensor device comprises, in addition to the optical sensor unit, further, in particular non-optical, sensors which register and record environmental data, in particular ground and/or atmospheric data. The term “rod-shaped” is to be understood in particular as having an elongated shape, preferably a shape in which a maximum longitudinal extension is at least five times greater, preferably at least ten times greater than a maximum transverse extension. In particular, the anchoring device extends over at least 20%, preferably at least 30% and preferably at least 40% of the maximum longitudinal extension of the base body. In particular, at least one further sensor of the agricultural sensor device is arranged in the region of the anchoring device. In particular, the anchoring device has a pointed end or a drilling spiral.

If the optical sensor unit of the device for a detection of a sprouting of seeds is arranged at least partially in a proximity of an above-ground head end of the base body, preferably at the upper head end of the base body, a particularly good monitoring of seeds can advantageously be achieved. Advantageously, the largest possible agricultural area region can be monitored from the top view. In particular, the optical sensor unit, preferably an objective of the optical sensor unit, is arranged at least 150 cm, advantageously at least 100 cm, preferably at least 75 cm and particularly preferably at least 50 cm above the soil forming the agricultural area region to be monitored. In the case of particularly high-growth plants, such as e.g. maize, an even higher embodiment of the device (e.g. 3 m or 3.5 m) is also conceivable. In this context, a “proximity” is to be understood in particular as meaning a region which is formed by points which are less than 20 cm, preferably less than 10 cm away from the head end of the base body. The head end of the base body forms in particular a head end of an agricultural sensor forming the agricultural sensor device.

Additionally, it is proposed that the agricultural sensor device, in particular the agricultural sensor rod, comprises at least one soil moisture sensor, at least one soil temperature sensor, at least one soil chemistry sensor, for example for CO₂, nitrate, certain fertilizers, certain plant protection agents, etc. and/or at least one above-ground weather sensor. Advantageously, a correlation of further measured values assigned to the agricultural area region or an environment of the agricultural area region with the field emergence can thereby be made possible. Advantageously, a determination of the field emergence can thereby be made more precise and/or findings for optimizing the field emergence can advantageously be obtained. It is conceivable, for example, that a germination window can already be limited in advance of the field emergence by including the soil temperature, so that, for example, prompt preparations for further steps can be made. In particular, it is conceivable that the soil temperature sensor is configured to detect a depth-dependent soil temperature profile. In particular, it is conceivable that the soil moisture sensor is configured to detect a depth-dependent soil moisture profile. In particular, it is conceivable that the soil temperature sensor, the soil chemistry sensor and/or the soil moisture sensor comprises a plurality of sensor probes arranged at different depths. In particular, the weather sensor is configured to register and/or record an air temperature, an air humidity, a solar radiation, an amount of rain, a wind direction and/or a wind speed. In particular, the data processing unit of the device for a detection of a sprouting of seeds can be formed integrally with a common data processing unit of the agricultural sensor rod or separately from further data processing units of the agricultural sensor rod. In addition, it is conceivable that the agricultural sensor device, in particular the optical sensor unit, is configured for a detection of a leaf moisture. For example, a leaf moisture is detectable via a color analysis of leaf colors or via a detection of droplets lying on leaves. Advantageously, a function of the irrigation system can thereby be monitored, for example.

It is further proposed that the device has a scale marking arranged in a field of view of an optical sensor unit of the device for a detection of a sprouting of seeds for enabling a determination of a growth rate by automated comparisons of image data and/or a chemical or physical indicator element arranged in the field of view of the optical sensor unit of the device for a detection of a sprouting of seeds, which is configured to optically represent a current environmental parameter. Advantageously, a reliable growth rate determination can thereby be made possible. Advantageously, an improved separation of crop plants and accompanying vegetation on the basis of different growth rates can additionally be achieved, whereby advantageously a risk of an incorrect determination of the field emergence can be reduced. In particular, the scale marking is applied to an above-ground surface of the base body. Alternatively, the scale marking can be fastened separately from the base body via a separate component in the ground. An “environmental parameter” is to be understood in particular as meaning a pH value, a temperature, a humidity and/or an (integrated) UV radiation intensity. The chemical or physical indicator element can be formed here for example as a pH measuring strip, as a moisture measuring strip, as a scale thermometer or as a UV indicator element, e.g. a UV indicator element, the coloring of which bleaches depending on a UV exposure duration. Alternatively or additionally, it is also conceivable that further markings are applied in the field of view of the optical sensor unit, which can feed local information into the system in an automated manner via shape, color or pattern. These can be e.g. barcodes printed on plastic platelets, such as QR codes or DataMatrix codes, etc. or colored flags. These markings can be placed for example manually by the user into the field of view of the optical sensor unit, so that the markings can then be detected in an automated manner in order to support the classification (e.g. with plant types determined manually on site), to supply additional information or to support an efficient training of the algorithms.

Furthermore, an agricultural monitoring and/or agricultural control method is proposed, wherein in a monitoring step image data recorded repeatedly or continuously from a top view of an agricultural area region are evaluated by a data processing unit for automated detection of sprouting times of seeds within the agricultural area region. An agricultural cultivation process can thereby advantageously be optimized. Advantageously, an optimized irrigation, plant protection and/or fertilizing measures plan can thereby be created.

Additionally, it is proposed that the image data for a detection of the sprouting times are evaluated close to the sensor. Advantageously, a particularly long battery and/or accumulator runtime and/or a high manipulation safety can thereby be achieved. The expression “close to the sensor” is to be understood in particular at the location of the agricultural sensor. Preferably, in the case of an analysis close to the sensor, the determined data, in particular image data, are evaluated and/or processed before a transmission by means of a data transmission unit or the like and/or immediately after a recording at the location of the recording.

If upon detection of a sprouting of a plant sprout in a notification step a notification of the sprouting time is sent externally, an optimal utilization of the obtained data can advantageously be ensured. Advantageously, an optimized control of external systems, such as irrigation, fertilizing and/or plant protection systems, can thereby be achieved. The notification of the sprouting time can be realized as a pure text message (without the image data).

If additionally in a check step a transmission of image data of the agricultural area and/or of a detected plant sprout can be requested by a recipient of the notification, a particularly user-friendly and/or reliable agricultural monitoring and/or control can advantageously be ensured.

If in a further method step following the check step an image section of the requested image data limited to the detected plant sprout is transmitted to the recipient, a data transfer volume can advantageously be kept low, whereby a long accumulator or battery runtime can advantageously be achieved. Alternatively, however, it is also conceivable that complete and unprocessed and/or unchanged image data are transmitted to the recipient.

If the image data and the notifications are transmitted to the recipient using different, in particular wireless, network protocols, a particularly energy-efficient agricultural monitoring and/or control can be made possible. In particular, the notifications transmitted (frequently and in text form or in bandwidth-saving form) are transmitted via a more energy-saving (wireless) network protocol than the (less frequently) transmitted image data. Alternatively, however, it is also conceivable that image data and notifications are transmitted via identical wireless network protocols or that at least one of the transmissions, preferably the image data transmission, takes place non-wirelessly, e.g. wired or via a USB mass memory, or that at least one of the transmissions, preferably the image data transmission, takes place via a direct satellite connection, such as e.g. Griot.

Further, it is proposed that in an algorithm training step a feedback of the recipient with respect to a correctness of a plant sprout detection carried out is executed for an automated optimization and/or for an automated training (e.g. a “supervised learning” of a neural network) of an algorithm carrying out the plant sprout detection, in particular of the detection algorithm and/or of the classification algorithm, in particular of the object classification algorithm. Advantageously, a continuous optimization of the plant sprout detection can thereby be achieved. Advantageously, a continuous adaptation to local conditions can additionally be achieved. In particular, a networking of a plurality of distributed agricultural sensor devices can be achieved via the data transmission unit. For example, in this case findings obtained by machine learning could be exchanged between the networked agricultural sensor devices and thus the algorithm training step could be further improved. For example, in the algorithm training step a plant classification, in particular a plant classification code, a field emergence detection, a sprouting time determination, etc. is confirmed or rejected by the recipient after a receipt of the image data. In particular, preceding confirmations or rejections in the creation of future plant classifications, in particular plant classification codes, field emergence detections, sprouting time determinations, etc., are taken into account by the detection algorithm and/or the classification algorithm, in particular the object classification algorithm. It is conceivable that the algorithm training step takes place internally in the data processing unit of the device for a detection of the sprouting of seeds. Preferably, however, the algorithm training step is outsourced, in particular due to the requirements for a computing power, to an external data processing unit, which is in contact with the device via the data transmission unit, for example.

Additionally, it is proposed that in a planning and/or control step, on the basis of the determined sprouting time of a plant sprout associated with the seed, a rearing planning and/or harvesting scheduling is created. A rearing of the plants can thereby advantageously be optimized and/or a harvesting quantity can be maximized. In particular, the rearing planning and/or the harvesting scheduling comprise machine availabilities, employee work plans, fertilization times, irrigation times, plant protection application times, soil processing times, harvesting sequences, storage and/or transport planning, etc. In particular, the planning and/or control step can take place close to the sensor, wherein corresponding messages are distributed by the data transmission unit. Preferably, however, the planning and/or control step takes place in planning and/or control devices external to the sensor, which process the findings/measurement results of the agricultural sensor device and convert them into actions or instructions for actions.

In addition, it is proposed that in a cultivation step, on the basis of the detection of a presence of a sprouting plant sprout associated with the seed, in particular the desired crop plant, and/or on the basis of the determined sprouting time of a plant sprout associated with the seed, in particular the desired crop plant, a soil management system, for example an irrigation system, a plant protection system and/or a fertilizer system, is controlled in an automated manner, in particular activated in an automated manner, deactivated in an automated manner or an output is throttled in an automated manner or increased in an automated manner. A particularly targeted agricultural management and thus a potential increase in yield can thereby advantageously be made possible. Advantageously, emergence diseases or relapse diseases of the seedlings can thereby be avoided. For example, an irrigation can be returned or adjusted after a detection of a field emergence in order to prevent the occurrence of emergence diseases triggered, for example, by moisture-loving fungal pathogens such as Pythium or Fusarium.

If, in addition, in the automated control of the soil management system, in particular of the irrigation system, the plant protection system and/or the fertilizer system, measurement data of a parallel measurement of a soil moisture, a soil temperature and/or a local weather are taken into account in the cultivation step, in particular by the further sensors of the agricultural sensor device, an agricultural optimization process can advantageously be further improved so that potentially even higher harvesting quantities can be achieved and/or so that risks for harvest failures can be further reduced.

If, in addition, in the automated control of the plant protection system in the cultivation step a corresponding weed killer is proposed/selected on the basis of a detection of a weed type, in particular on the basis of the plant classification codes, a particularly effective weed control can advantageously be achieved.

It is further proposed that in a first substep of the monitoring step a density of plant sprouts per unit area in the agricultural area region is determined from the image data recorded of the agricultural area region and that in a second substep of the monitoring step the density of plant sprouts in the agricultural area region is compared with a known seed density per unit area in the agricultural area region for determining a relative sowing success. Advantageously, an efficiency of the field emergence can thereby be determined. Advantageously, a conclusion on optimal sowing quantities can thereby be obtained. In particular, the optimal sowing quantities can be determined in a soil-specific and/or climate-specific manner when including the measurement data of the further sensors of the agricultural sensor device. Advantageously, the data on the relative sowing success can be stored in a database together with climate and soil data of the further sensors of the agricultural sensor device. This database can then be used for sowing recommendations or the like in future new plantings or for optimizing sowing quantities in existing plantings.

Furthermore, it is proposed that in a sowing optimization step a database of determined soil-type-dependent relative sowing successes is queried and based thereon a soil-type-optimized sowing quantity is proposed for future seeds. Advantageously, a sowing quantity can thereby be optimally adapted to a plant location. In particular, effects due to soil processing, plant protection agents or fertilizers can also be included in such a database with the relative sowing successes. Additionally, an actually achieved harvesting quantity can be included in the evaluation.

Furthermore, an agricultural monitoring and/or agricultural control system with at least one device for a detection of a sprouting of seeds with a control and/or regulating device, which is configured at least to control a soil management system, such as for example an irrigation system, a plant protection system and/or a fertilizer system, within the framework of executing the agricultural monitoring and/or agricultural control method, is proposed. Advantageously, an integrated plant cultivation system can thereby be created, which can in particular lead to an advantageous increase in yield.

The device according to the invention for a detection of a sprouting of seeds, the agricultural sensor device according to the invention, the agricultural monitoring and/or agricultural control method according to the invention and the agricultural monitoring and/or agricultural control system according to the invention shall not be limited here to the above-described application and embodiment. In particular, the device according to the invention for a detection of a sprouting of seeds, the agricultural sensor device according to the invention, the agricultural monitoring and/or agricultural control method according to the invention and the agricultural monitoring and/or agricultural control system according to the invention can have a number deviating from a number of individual elements, components, method steps and units mentioned herein in order to fulfill a functionality described herein.

### FIGURES

Further advantages emerge from the following description of the figures. An exemplary embodiment of the invention is illustrated in the figures. The figures, the description and the claims contain numerous features in combination. The person skilled in the art will expediently also consider the features individually and combine them to form further meaningful combinations.

It is shown in:

FIG. 1 a schematic illustration of an agricultural monitoring and/or agricultural control system with a plurality of agricultural sensor devices,

FIG. 2 a schematic illustration of the agricultural sensor device formed by way of example as an agricultural sensor rod with a device for a detection of a sprouting of seeds, and

FIG. 3 a schematic flowchart of an agricultural monitoring and/or agricultural control method.

### DETAILED DESCRIPTION

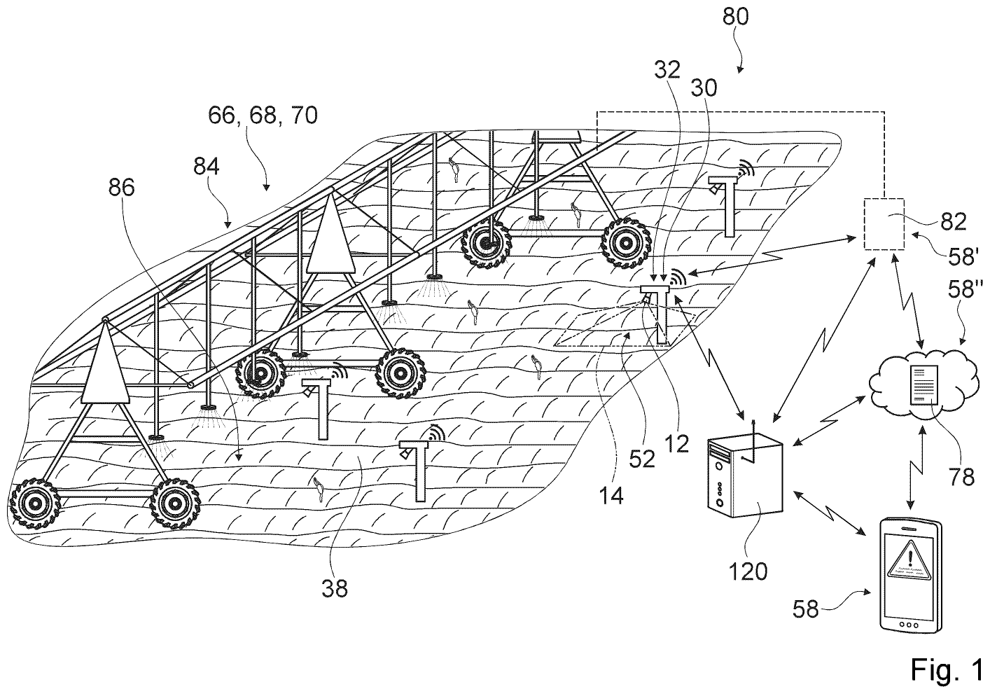

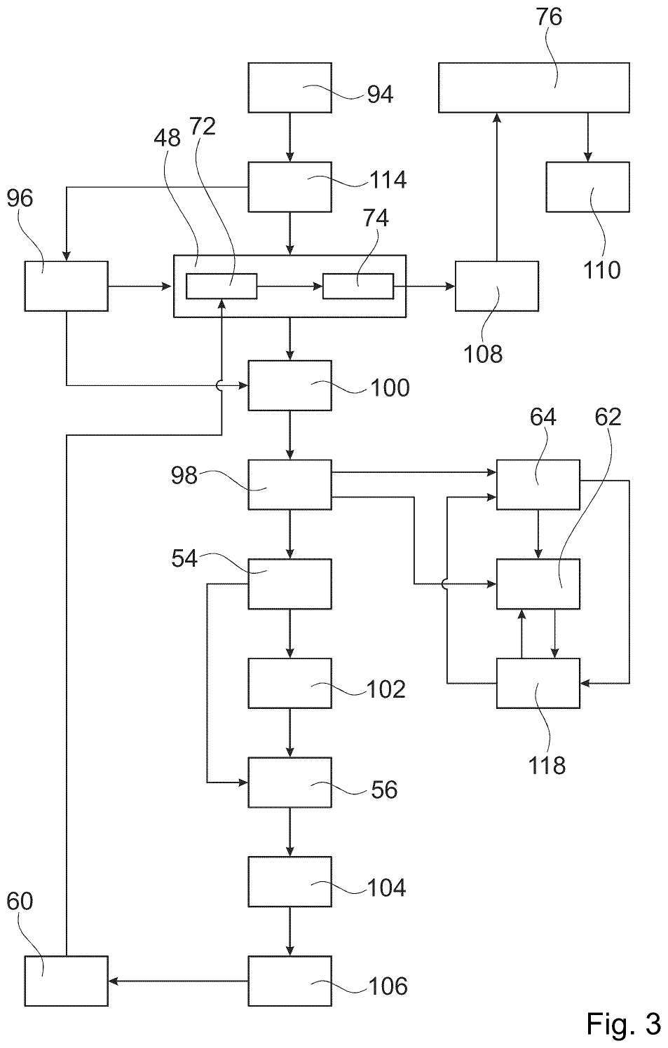

FIG. 1 schematically shows an exemplary agricultural monitoring and/or agricultural control system 80. The agricultural monitoring and/or agricultural control system 80 is configured for monitoring and/or for controlling agricultural processes, such as for example irrigation, fertilization and/or plant protection. The agricultural monitoring and/or agricultural control system 80 is configured for monitoring an agricultural cultivation area 86 and/or for controlling an agricultural management of the cultivation area 86. The agricultural monitoring and/or agricultural control system 80 comprises a soil management system 84. The soil management system 84 illustrated by way of example is formed as an irrigation system 66. Alternatively or additionally, the soil management system 84 could also comprise a plant protection system (not shown) and/or a fertilizer system (not shown). In addition, the illustrated irrigation system 66 can be used as a plant protection system 68 and/or as a fertilizer system 70 by adding plant protection agents and/or fertilizers. The embodiment of the soil management system 84 can differ substantially from the exemplary illustration from FIG. 1. The soil management system 84 comprises a control and/or regulating device 82. A “control and/or regulating device 82” is to be understood in particular as meaning a device with at least one control electronics system. A “control electronics system” is to be understood in particular as meaning a unit with a processor and with a memory and with an operating program stored in the memory and executable by the processor. The control and/or regulating device 82 is configured at least to control the soil management system 84 within the framework of executing an agricultural monitoring and/or agricultural control method (cf. also FIG. 3).

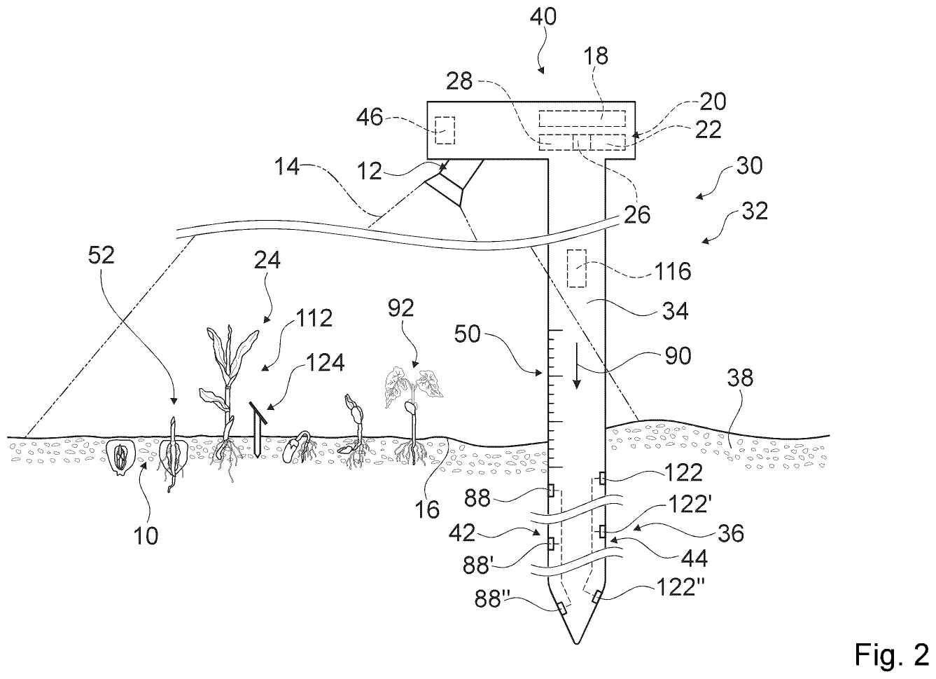

The agricultural monitoring and/or agricultural control system 80 comprises agricultural sensor devices 32. The agricultural sensor devices 32 are formed as agricultural sensor rods or agricultural sensor posts. A plurality of agricultural sensor devices 32 are distributed on the cultivation area 86 illustrated by way of example in FIG. 1. The agricultural sensor devices 32 each have a device 30 which is configured for a detection of a sprouting of seeds 10 (cf. FIG. 2). A plurality of agricultural sensor devices 32 can be networked with one another, for example via their data transmission units 20. In FIG. 1, the data transmission units 20 communicate externally by way of example via a gateway 120, e.g. via an LPWAN gateway, such as a LoRaWAN gateway.

FIG. 2 shows an exemplary schematic illustration of an agricultural sensor device 32 formed as an agricultural sensor rod. The agricultural sensor device 32 comprises a base body 34. The base body 34 is formed in a rod-shaped manner. The base body 34 comprises an anchoring device 36. The anchoring device 36 is configured to anchor the base body 34 in a ground 16. In the illustrated example, the ground 16 is formed as a soil 38 of the cultivation area 86. A seed 10 is introduced into the soil 38. The seed 10 consists of seeds of a desired crop plant 112 (here: maize). For exemplary illustration, the seed 10 is illustrated in different germination stages. In addition, random further seeds are present in the soil 38, from which accompanying vegetations 92 differing from the desired crop plant 112 germinate spontaneously. The farmer commonly refers to this accompanying vegetation 92 as weed. In the example illustrated in FIG. 2, the crop plant 112 is a monocotyledonous plant and the accompanying vegetation 92 is a dicotyledonous plant. The accompanying vegetation 92 is commonly referred to as weed and is generally undesired.

The agricultural sensor device 32 comprises a soil moisture sensor 42. The soil moisture sensor 42 comprises a plurality of soil moisture sensor probes 88, 88′, 88″. The soil moisture sensor probes 88, 88′, 88″ are arranged spaced apart from one another in the longitudinal direction 90 of the base body 34 at different locations of the anchoring device 36 of the base body 34. The soil moisture sensor probes 88, 88′, 88″ are arranged at different depths of the soil 38. The soil moisture sensor probes 88, 88′, 88″ are configured to determine the soil moisture at different depths of the soil 38. The agricultural sensor device 32 comprises a soil temperature sensor 44. The soil temperature sensor 44 comprises a plurality of soil temperature sensor probes 122, 122′, 122″. The soil temperature sensor probes 122, 122′, 122″ are arranged spaced apart from one another in the longitudinal direction 90 of the base body 34 at different locations of the anchoring device 36 of the base body 34. The soil temperature sensor probes 122, 122′, 122″ are arranged at different depths of the soil 38. The soil temperature sensor probes 122, 122′, 122″ are configured to determine the soil temperature at different depths of the soil 38. The agricultural sensor device 32 additionally comprises a plurality of soil chemistry sensors (not explicitly illustrated). The agricultural sensor device 32 comprises an above-ground weather sensor 46. The agricultural sensor device 32 comprises an internal energy supply 116. The internal energy supply 116 is formed as an accumulator or as a battery.

The agricultural sensor device 32 comprises the device 30 for a detection of the sprouting of the seeds 10. The device 30 for a detection of the sprouting of the seeds 10 is assigned to the base body 34. The device 30 for a detection of the sprouting of the seeds 10 comprises an optical sensor unit 12. The optical sensor unit 12 is formed as a camera. The optical sensor unit 12 is arranged in a proximity of an above-ground head end 40 of the base body 34. The optical sensor unit 12 is configured to record image data of the ground 16 repeatedly or continuously in an agricultural area region 52 of the ground 16. The optical sensor unit 12 comprises a field of view 14. The agricultural sensor device 32 is illustrated in FIG. 2 in a designated operation and/or installation state. In the designated operation and/or installation state, the optical sensor unit 12 is aligned from a top view onto the ground 16. In the designated operation and/or installation state, the field of view 14 of the optical sensor unit 12 is aligned obliquely or perpendicularly in the direction of the ground 16.

The device 30 for a detection of the sprouting of the seeds 10 is embodied as a seedling detection device. The device 30 for a detection of the sprouting of the seeds 10 is embodied as a field emergence detection device. The device 30 for a detection of the sprouting of the seeds 10 comprises a data processing unit 18. The data processing unit 18 is configured to evaluate the image data recorded by the optical sensor unit 12 for a detection of sprouting times of the seeds 10. The data processing unit 18 is configured to evaluate the image data recorded by the optical sensor unit 12 for a detection of the field emergence. The data processing unit 18 comprises a microcontroller which is configured to detect the sprouting times by evaluating the image data. The data processing unit 18 (comprising the microcontroller) represents an analysis possibility close to the sensor for the analysis of the image data recorded by the optical sensor unit 12. The data processing unit 18, in particular the microcontroller of the data processing unit 18, is configured to execute at least one detection algorithm, one classification algorithm and/or one object classification algorithm for evaluating the image data of the optical sensor unit 12. The data processing unit 18, in particular the microcontroller of the data processing unit 18, is configured to detect and/or classify plant sprouts 24 sprouting from the soil 38. The data processing unit 18, in particular the microcontroller of the data processing unit 18, is configured to at least roughly detect and/or at least roughly classify plant sprouts 24 early, in particular at the latest at an 8-leaf phase, preferably at the latest at a 4-leaf phase. The data processing unit 18, in particular the microcontroller of the data processing unit 18, is configured to execute a detection algorithm, a classification algorithm and/or an object classification algorithm for detecting/classifying the plant sprouts 24 from the image data of the optical sensor unit 12. The data processing unit 18, in particular the microcontroller of the data processing unit 18, is configured to detect/classify the plant sprouts 24 by Al/by neural networks.

The device 30 for a detection of the sprouting of the seeds 10 comprises a data transmission unit 20. The data transmission unit 20 is configured to send a notification of the sprouting time externally, in particular to a recipient 58, 58′, 58″ (cf. FIG. 1), upon detection of a sprouting of the seed 10. The data transmission unit 20 comprises a transmitter 22. The transmitter 22 is formed as a low-energy transmitter. The transmitter 22 is configured to send data, in particular the notifications of the sprouting time, via a low power wide area network protocol (LPWAN network protocol), such as NB-IoT, LoRaWAN or mioty. The transmitter 22 is configured to send one or several plant classification codes determined on the basis of the recorded image data externally, in particular to a recipient 58, 58′, 58″ (cf. FIG. 1), upon detection of the sprouting of the seed 10 by the data processing unit 18. The recipient 58, 58′, 58″ can be formed among others as a mobile device of a user, e.g. a farmer, as a cloud service or also directly as the soil management system 84. The transmitter 22 regularly (e.g. every minute, every ten minutes, half-hourly, hourly, 3-hourly, etc.) and/or automatically sends plant classification codes externally. Alternatively, it is conceivable that the transmitter sends the plant classification codes only upon request. Alternatively, it is also conceivable that the transmitter sends the plant classification codes only upon detection of a change with respect to a previously sent message, i.e. for example upon new detection of a previously non-present plant shoot 24. Advantageously, a long accumulator or battery lifetime of the internal energy supply 116 of the agricultural sensor device 32 can thereby be achieved.

The plant classification code can contain a piece of information about whether one or several plant sprouts 24 have been detected by the data processing unit 18. The plant classification code can contain a number of plant sprouts 24 which have been detected by the data processing unit 18 in the agricultural area region 52. The plant classification code can contain a piece of information about which plant type(s) has/have been detected by the data processing unit 18. The plant classification code can contain a piece of information about whether a desired plant type (e.g. that of the crop plant 112) or an undesired plant type (e.g. that of the accompanying vegetation 92) has been assigned to a plant sprout 24 by the data processing unit 18. The plant classification code can contain a piece of information about how many plant sprouts 24 have been detected per unit area by the data processing unit 18 in the agricultural area region 52.

The data transmission unit 20 comprises at least one receiver 28. The receiver 28 is configured to externally receive response data upon the data sent externally, in particular plant classifications, e.g. response data that are sent back by one of the receivers 58, 58′, 58″ to the data transmission unit 20. The receiver 28 is formed as a low-energy receiver. The receiver 28 is configured to forward the response data to the data processing unit 18 for a training of detection algorithms of the data processing unit 18 and/or of classification algorithms, in particular object classification algorithms, of the data processing unit 18.

The data transmission unit 20 comprises a further transmitter 26. The further transmitter 26 is configured to send the image data of the optical sensor unit 12 externally, e.g. to one of the receivers 58, 58′, 58″. The further transmitter 26 is substantially more broadband compared to the transmitter 22. The further transmitter 26 is configured to send image data, which show the detected first-sprouting plant sprout 24, externally upon first detection of a sprouting of a plant sprout 24 automatically and/or upon instruction by an external recipient 58, 58′, 58″. The further transmitter 26 sends data substantially less frequently than the transmitter 22. The data processing unit 18 is configured to crop the image data before sending for data reduction in such a way that the sent image data comprise only a reduced image section, which represents the detected first-sprouting plant sprout 24 or the newest currently growing plant sprout 24.

The data processing unit 18 is configured to evaluate image data of the optical sensor unit 12 at least for a detection of growth rates of plant sprouts 24. The data transmission unit 20 is configured to send the determined growth rates externally. The agricultural sensor device 32 comprises a scale marking 50. The scale marking 50 is applied at least partially to an outer side of an above-ground part of the base body 34. The scale marking 50 is arranged in the field of view 14 of the optical sensor unit 12. The scale marking 50 is configured to enable a determination of a growth rate by automated comparisons of image data. The data processing unit 18 is configured to determine a change in a growth height of a plant, in particular a plant associated with the crop plant 112 or the accompanying vegetation 92, on the basis of the image comparisons. Alternatively, the scale marking 50 can also be formed separately from the base body 34, for example separately insertable into the soil 38. Alternatively or additionally to the scale marking 50, a chemical or physical indicator element 124 or another marking, such as a barcode, can also be arranged in the field of view 14 of the optical sensor unit 12, so that e.g. the chemical or physical indicator element 124 or the marking can be evaluated and/or read out by image recognition and/or image analysis, in particular with the aid of the data processing unit 18.

FIG. 3 shows a schematic flowchart of an agricultural monitoring and/or agricultural control method. In at least one method step 94, an agricultural sensor device 32, in particular an agricultural sensor rod, is anchored in the ground 16. In at least one further method step 114, the field of view 14 of the optical sensor unit 12 is aligned such that it detects the agricultural area region 52 from the top view. In a monitoring step 48, the image data recorded from the top view of the agricultural area region 52 are repeatedly or continuously evaluated by the data processing unit 18 for automated detection of the sprouting times of the seeds 10 within the agricultural area region 52. The image data are evaluated close to the sensor in the monitoring step 48 for a detection of the sprouting times. In the monitoring step 48, a plant shoot identification is performed on the basis of the image data. In the monitoring step 48, a detection and/or a classification of identified plant sprouts 24 is performed. In at least one further monitoring step 96, further sensor data are detected by sensors different from the optical sensor unit 12, such as, for example, the soil moisture sensor 42, the soil temperature sensor 44, the weather sensor 46 and/or the soil chemistry sensors (not shown). In the further monitoring step 96, the further sensor data are recorded regularly or continuously. It is conceivable that, for an improvement of the result, the further sensor data are included in the detection and/or classification of the identified plant sprouts 24. On the basis of the result of the detection and/or classification of the identified plant sprouts 24, reports are created in a further method step 100. The reports comprise, among others, the plant classification codes assigned to the identified plant sprouts 24. In addition, the reports can comprise, for example, measurement data of the further sensors.

In an optional substep 72 of the monitoring step 48, a density of plant sprouts 24 per unit area in the agricultural area region 52 is determined from the image data recorded of the agricultural area region 52. In an optional further substep 74 of the monitoring step 48, the density of plant sprouts 24 in the agricultural area region 52 is compared with a seed density per unit area in the agricultural area region 52 known from a preceding sowing process for determining a relative sowing success. In a further method step 108, the determined, in particular soil-type-dependent, sowing success can be transmitted together with associated measurement data of the agricultural sensor device 32, for example with respect to a soil type of the cultivation area 86 in which the monitored sowing has taken place, to an external database 78, for example to a worldwide accessible cloud database. Subsequently, in a sowing optimization step 76 the database 78 comprising the determined soil-type-dependent relative sowing successes can be queried. In a further method step 110, on the basis of the soil type indicated in the query and/or a crop plant indicated in the query, a soil-type-optimized sowing quantity is proposed for future seeds. The proposed soil-type-optimized sowing quantity is determined based on the best relative sowing successes of comparable crop plants in soils of comparable type reported to the database 78.

Upon detection of a sprouting of a plant sprout 24, in a notification step 98 a notification of the sprouting time is sent externally. The notification is transmitted via the low power wide area network protocol. The notification comprises at least partially the content of the reports. The notification comprises at least the plant classification codes assigned to the identified plant sprouts 24. The notification can be transmitted to a human recipient 58, who thereby receives support for his agricultural decisions. However, the notification can also be transmitted to a non-human recipient 58′, 58″, for example an at least partially automated system, for example to the agricultural monitoring and/or agricultural control system 80, which controls and/or regulates a process or a connected system, for example the irrigation system 66, the plant protection system 68 and/or the fertilizer system 70, based on the information contained in the notification.

If the notification is transmitted to the human recipient 58, the notification is displayed to the recipient 58 in the notification step 98. In a check step 54, a transmission of image data of the agricultural area 52 and/or of the detected plant sprout 24 can then be requested by the recipient 58 of the notification. In a further method step 102, the image data are cropped before sending by the data transmission unit 20 such that the image data comprise only an image section, which is restricted to the detected plant sprout 24. In a further method step 56 following the check step 54, the image section of the requested image data limited to the detected plant sprout 24 is transmitted to the recipient 58. Alternatively, it is also conceivable that the entire image data are transmitted in the method step 56 or that the recipient 58 can make a selection whether he wants to have cropped or complete image data transmitted. The image data are transmitted via a network protocol (non-LPWAN network protocol) different from the low power wide area network protocol (LPWAN network protocol). The image data and the notifications are each transmitted to the recipient 58 using different network protocols. The image data and the notifications are each transmitted to the recipient 58 using different transmitters 22, 26 of the data transmission unit 20. In at least one further method step 104, the received image data are assessed by the recipient 58.

In at least one further method step 106, a feedback based on the assessment of the image data with respect to a correctness of a plant sprout detection carried out is sent back to the device 30 for a detection of the sprouting of the seeds 10. In an algorithm training step 60, the feedback with respect to the correctness of the plant sprout detection carried out is executed for an automated optimization and/or for an automated training of an algorithm of the data processing unit 18 carrying out the plant sprout detection, in particular within the framework of a training and/or a training of a neural network.

If the notification is transmitted to the non-human recipient 58′, 58″, the notification is evaluated in the notification step 98 by an operating program of the non-human recipient 58′, 58″, for example by the control and/or regulating device 82 of the agricultural monitoring and/or agricultural control system 80 and/or by a further control and/or regulating device different therefrom. In a planning and/or control step 62, on the basis of the determined sprouting time/field emergence of the plant sprout 24 associated with the seed 10, a rearing planning and/or harvesting scheduling is created. This rearing planning and/or harvesting scheduling can comprise the agricultural monitoring and/or agricultural control system 80 and/or further systems which are involved in the management of the cultivation area 86. In a cultivation step 64, on the basis of the detection of a presence of the sprouting plant sprout 24 associated with the seed 10 and/or on the basis of the determined sprouting time/field emergence of the plant sprout 24 associated with the seed 10 and/or on the basis of the rearing planning and/or the harvesting scheduling of the planning and/or control step 62, a soil management system 84, for example the irrigation system 66, the plant protection system 68 and/or the fertilizer system 70, is controlled in an automated manner. In the automated control of the soil management system 84, in particular of the irrigation system 66, the plant protection system 68 and/or the fertilizer system 70, the measurement data of parallel measurements of a soil moisture, a soil temperature and/or a local weather are additionally taken into account in the cultivation step 64. Advantageously, the soil moisture and/or the fertilizer concentration is thereby advantageously kept at an optimal value for a detected development step of the crop plant 112, for example. In the automated control of the plant protection system 68 in the cultivation step 64 a corresponding weed killer can be proposed/selected on the basis of a detection of a weed type. In the case of a detection of dicotyledonous weeds between monocotyledonous crop plants, for example, a weed killer acting only on dicotyledonous plants can be used in a selective manner. In the case of a detection of an emergence of weeds before a field emergence of the crop plant 112 has started, for example, a broadband weed killer can be used. In a further cultivation step 118 a growth rate and/or a growth height of the crop plant 112 and/or the accompanying vegetation 92 is determined from the image data with the aid of the scale marking 50. The results of the further cultivation step 118 can be used in a feedback manner for optimizations of the cultivation step 64 and/or of the planning and/or control step 62.

Additionally, it is conceivable that a detection of a field emergence takes place based on a combination of data, in particular of plant sprout detection data, of detected sprouting times and/or of plant classification codes, of a plurality of agricultural sensor devices 32 distributed over the cultivation area 86. If for example in more than one, advantageously in more than two, particularly advantageously in more than 20%, preferably in more than 30% and particularly preferably in more than 50% of all fields of view 14 of the agricultural sensor devices 32 distributed over the cultivation area 86 a sprouting time, in particular a plant sprout 24, preferably a plant sprout 24 of the crop plant 112, is detected, a notification with respect to the positive detection of the field emergence is sent externally. In particular, the notifications sent externally by the data transmission units 20 comprise a number of all agricultural sensor devices 32 which have detected plant sprouts 24, in particular plant sprouts 24 of the crop plant 112, or a proportion of the agricultural sensor devices 32 which have detected the plant sprouts 24, in particular plant sprouts 24 of the crop plant 112, on all agricultural sensor devices 32 distributed over the cultivation area 86. Advantageously, a reliability of the field emergence determination and/or of the sprouting time can thereby be substantially improved.

1. A device for a detection of a sprouting of seeds, in particular a seedling detection device and/or a field emergence detection device, with an optical sensor unit, the field of view of which is aligned in a designated operation and/or installation state from a top view onto a ground and which is configured to record image data repeatedly or continuously, and with a data processing unit, which is configured to evaluate the image data of the optical sensor unit at least for a detection of sprouting times of seeds.

2. The device according to claim 1, further comprising a data transmission unit, which is configured at least to send a notification of the sprouting time externally upon detection of a sprouting of the seed.

3. The device according to claim 2, wherein the data transmission unit has at least one transmitter, which is configured to send data via a low power wide area network protocol, such as NB-IoT, LoRaWAN or mioty.

4. The device according to claim 3, wherein the transmitter is configured to send one or several plant classification codes externally upon detection of the sprouting of the seed by the data processing unit.

5. The device according to claim 4, wherein a plant classification code contains at least one piece of information about whether one or several plant sprouts have been detected by the data processing unit.

6. The device according to claim 4, wherein a plant classification code contains at least one piece of information about which plant type(s) has/have been detected by the data processing unit and/or whether a plant sprout has been assigned to a desired or an undesired plant type by the data processing unit.

7. The device according to claim 4, wherein a plant classification code contains at least one piece of information about how many plant sprouts have been detected per unit area by the data processing unit.

8. The device according to claim 2, wherein the data transmission unit has a transmitter, which is configured to send the image data of the optical sensor unit externally.

9. The device according to claim 8, wherein the transmitter is configured to send image data, which show the detected first-sprouting plant sprout, externally upon first detection of a sprouting of a plant sprout automatically and/or upon instruction by an external recipient.

10. The device according to claim 9, wherein the data processing unit is configured to crop the image data before sending for data reduction in such a way that the sent image data comprise only a reduced image section, which represents the detected first-sprouting plant sprout.

11. The device according to claim 2, wherein the data transmission unit has at least one receiver, which is configured at least to externally receive response data upon the data sent externally.

12. The device according to claim 11, wherein the receiver is configured at least to forward the response data to the data processing unit for a training of detection algorithms of the data processing unit and/or of classification algorithms.

13. The device according to claim 1, wherein the data processing unit comprises at least one microcontroller for a detection of the sprouting times by evaluating the image data.

14. The device according to claim 13, wherein the microcontroller is configured to execute at least one object classification algorithm for evaluating the image data of the optical sensor unit, in particular for a detection of plant sprouts in the image data of the optical sensor unit.

15. The device according to claim 1, in wherein the data processing unit is configured to evaluate image data of the optical sensor unit at least for a detection of growth rates of plant sprouts, wherein the data transmission unit is configured at least to send the determined growth rates externally.

16. An agricultural sensor device, comprising an, in particular rod-shaped, base body with an anchoring device for an at least partial sinking into a ground, and comprising a device according to claim 1 assigned to the base body for a detection of a sprouting of seeds.

17. The agricultural sensor device according to claim 16, wherein an optical sensor unit of the device for a detection of a sprouting of seeds is arranged at least partially in a proximity of an above-ground head end of the base body.

18. The agricultural sensor device according to claim 16, further comprising at least one soil moisture sensor, at least one soil temperature sensor and/or at least one above-ground weather sensor.

19. The agricultural sensor device according to claim 16, characterized by further comprising a scale marking arranged in a field of view of an optical sensor unit of the device for a detection of a sprouting of seeds for enabling a determination of a growth rate by automated comparison of image data and/or by a chemical or physical indicator element arranged in the field of view of the optical sensor unit of the device for a detection of a sprouting of seeds, which is configured to optically display a current environmental parameter.

20. An agricultural monitoring and/or agricultural control method, in particular by means of a device according to claim 1, wherein in a monitoring step image data recorded repeatedly or continuously from a top view of an agricultural area region are evaluated by a data processing unit for automated detection of sprouting times of seeds within the agricultural area region.

21. The agricultural monitoring and/or agricultural control method according to claim 20, wherein the image data for a detection of the sprouting times are evaluated close to the sensor.

22. The agricultural monitoring and/or agricultural control method according to claim 20, wherein upon detection of a sprouting of a plant sprout, in a notification step a notification of the sprouting time is sent externally.

23. The agricultural monitoring and/or agricultural control method according to claim 22, wherein in a check step a transmission of image data of the agricultural area region and/or of a detected plant sprout can be requested by a recipient of the notification.

24. The agricultural monitoring and/or agricultural control method according to claim 23, wherein in a further method step following the check step, an image section of the requested image data limited to the detected plant sprout is transmitted to the recipient.

25. The agricultural monitoring and/or agricultural control method according to claim 23, wherein the image data and the notifications are transmitted to the recipient using different network protocols.

26. The agricultural monitoring and/or agricultural control method according to claim 23, wherein in an algorithm training step a feedback of the recipient with respect to a correctness of a plant sprout detection carried out is executed for an automated optimization and/or for an automated training of an algorithm carrying out the plant sprout detection.

27. The agricultural monitoring and/or agricultural control method according to claim 20, wherein in a planning and/or control step, on the basis of the determined sprouting time of a plant sprout associated with the seed, a rearing planning and/or harvesting scheduling is created.

28. The agricultural monitoring and/or agricultural control method according to claim 20, wherein in a cultivation step, on the basis of the detection of a presence of a sprouting plant sprout associated with the seed and/or on the basis of the determined sprouting time of a plant sprout associated with the seed, a soil management system, for example an irrigation system, a plant protection system and/or a fertilizer system, is controlled in an automated manner.

29. The agricultural monitoring and/or agricultural control method according to claim 28, wherein in the automated control of the soil management system, in particular of the irrigation system, the plant protection system and/or the fertilizer system, measurement data of a parallel measurement of a soil moisture, a soil temperature and/or a local weather are taken into account in the cultivation step.

30. The agricultural monitoring and/or agricultural control method according to claim 28, wherein in the automated control of the plant protection system, in the cultivation step a corresponding weed killer is proposed/selected on the basis of a detection of a weed type.

31. The agricultural monitoring and/or agricultural control method according to claim 20, wherein in a first substep of the monitoring step a density of plant sprouts per unit area in the agricultural area region is determined from the image data recorded of the agricultural area region, and that in a second substep of the monitoring step the density of plant sprouts in the agricultural area region is compared with a known seed density per unit area in the agricultural area region for determining a relative sowing success.

32. The agricultural monitoring and/or agricultural control method according to claim 30, wherein in a sowing optimization step a database of determined soil-type-dependent relative sowing successes is queried, and based thereon a soil-type-optimized sowing quantity is proposed for future seeds.

33. An agricultural monitoring and/or agricultural control system with at least one device for a detection of a sprouting of seeds according to claim 1, and with a control and/or regulating device, which is configured at least to control a soil management system, such as for example an irrigation system, a plant protection system and/or a fertilizer system, within the framework of executing an agricultural monitoring and/or agricultural control method.
